(19) United States
(12) Patent Application Publication
(10) Pub. No.: US 2005/0022154 A1
(43) Pub. Date: Jan. 27, 2005

(54) Interoperability of accounting packages and commerce servers

(75) Inventors: Jen-Yao Chung, Yorktown Heights, NY (US); Mitchell Adam Cohen, Yorktown Heights, NY (US); Vibby Gottemukkala, Holtsville, NY (US); Anant Deep Jhingran, Nanuet, NY (US)

Correspondence Address: F. CHAU & ASSOCIATES, LLC, 130 WOODBURY ROAD, WOODBURY, NY, 11797, US

(73) Assignee: International Business Machines Corporation, Armonk, NY (US)

(21) Appl. No.: 10/845,729

(22) Filed: May 14, 2004

Related U.S. Application Data
(63) Continuation-in-part of application No. 09/517,165, filed on Mar. 2, 2000.

(51) Int. Cl. G06F 17/60

(52) U.S. Cl. 717/100

(57) ABSTRACT

A method for transferring a structured document between a server and a software package, in accordance with the present invention, includes providing a structured document including entered information from a server and translating the structured document into a format understandable to a software package resident on a personal computer. The software package supports entering and extracting required information using only a user interface in the software package. The translated structured document is integrated into the software package by employing a program or applet for directly entering and extracting information to and from the software package without human intervention. The program includes operating system commands for mimicking input device actions for automatically interacting with the user interface.

### RELATED APPLICATION DATA

This present application is a continuation-in-part of commonly assigned application Ser. No. 09/517,165, filed on Mar. 2, 2000.

### BACKGROUND OF THE INVENTION

1. Field of the Invention

The present invention relates to e-commerce, and more particularly to a system and method for interoperability between commerce servers and business software.

2. Description of the Related Art

The proliferation of the Internet has opened the door for e-business (e-commerce) to small companies, a major change from the days when only large companies conducted automated business. Large companies have been using Electronic Data Interchange (EDI) and costly EDI systems and networks to exchange business documents for decades. Now, armed with just a personal computer (PC) web browser and an Internet connection, small companies can capitalize on the cost and accuracy of automated exchange. Large companies transacting with these small companies reap these same benefits too as they have for years with their larger trading partners.

In one example of e-commerce, a company puts business documents (such as purchase orders and/or invoices) on an e-commerce server to allow its trading partners or clients to view these documents in a browser. However, these trading partners or clients need to reflect the information from these business documents in their personal computer (PC) accounting packages. Similarly, these trading partners need to create business document replies for the company providing the server. The information for these replies is contained in the trading partners' PC accounting packages and must be sent to the server via the browser.

A trading partner enters the information in the documents viewed from the e-commerce server in its browser by typing the data into its PC accounting package. Many such PC accounting packages require human keyboard and/or mouse input in order to enter and extract transactions. Typically, the PC accounting packages have import functionality to allow externally created transactions to be brought into their systems and export functionality to allow transactions created internally to be used outside of the package. Executing these import and export functionalities often require input from the human interface devices, such as the keyboard and/or mouse. In some cases, the only way to perform the import and export functionalities is to perform some sequence of human interface device inputs. A problem is that many users are unfamiliar with the necessary steps to perform the import and export functionalities.

To reply to these documents (from the e-commerce server) by creating new documents in the e-commerce server via a browser, the trading partner must reenter the data previously entered and stored in its PC accounting package into the browser. This is not only time consuming, but also prone to typographical errors.

Small business can now view and create business documents using only a Web browser and an Internet connection to a business document exchange server run by a large partner or a third party. However, a customer study, performed by the present inventor's organization, showed that the majority of small companies who signed up for Web document exchange found it to be a burden as there is no integration with their current business document processing.

Without the Web, the normal process starts with the small company receiving sales orders from large partners in the mail or on their fax machine, both push techniques. That is, the orders are received passively. Next, the order gets typed into their PC accounting package, such as QUICKBOOKS™ or PEACHTREE™. When the order is shipped, the small company prints an invoice from their accounting software and faxes or mails the invoice to the large partner. At only one point is data typed into the accounting package.

With the Web, access to orders is a pull process where the small company must remember to actively check what orders have arrived. Of course, as long as e-mail accounts are checked regularly, e-mail notifications alleviate the need to constantly check for orders, quite useful when a small company is receiving small number of orders, such as two per year, from the large partner. Once the small partner browses the incoming order, it must then enter the data into its PC accounting system (as is the case with fax and mail orders). After shipping the order, the small company must take the invoice information from its accounting system and retype it into a Web browser form in order to transfer the data to the large company. This step is more work when compared to the non-Web scenario as now there is an extra set of keying in data.

In the study, it was found that more than half the companies who signed up to do business document exchange were dropping out. The extra processing was the biggest factor in their displeasure.

Therefore, a need exists for a system and method for automatically integrating business software packages with Web documents. A further need exists for eliminating the need to enter extra data in sending or replying to on-line business transaction, e.g., the browser (where the incoming document is viewed) needs to be integrated with the accounting package.

### SUMMARY OF THE INVENTION

A method for transferring a structured document between a server and a software package, in accordance with the present invention, includes providing a structured document including entered information from a server and translating the structured document into a format understandable to a software package resident on a personal computer. The software package supports entering and extracting required information using only a user interface in the software package. The translated structured document is integrated into the software package by employing a program or applet for directly entering and extracting information to and from the software package without human intervention. The program includes operating system commands for mimicking input device actions for automatically interfacing with the user interface.

In other methods, the step of integrating may include the step of moving a transaction represented by the structured document into the software package by employing a programming interface provided by the software package. The step of integrating may also include the step of moving a transaction represented by the structured document into the software package by creating a computer file in a format that can be imported into the software package. The structured document may include a business document and the software package may include business software. The structured document may include one of an invoice and a purchase order, and the software package may include accounting software. The structured document may include an extensible markup language (XML) document, and the step of translating may include the step of converting the XML document to another format using an extensible stylesheet language (XSL) document and an XSL processor. The step of translating may include the steps of converting the structured document to an intermediate format and converting the structured document from the intermediate format to the format understandable to the software package. The step of translating may include the step of invoking input and output adapters associated with the structured document for, respectively, parsing and creating an output format for the structured document. The methods and method steps may be implemented by employing a program storage device readable by machine, tangibly embodying a program of instructions executable by the machine to perform the method steps. The step of mimicking input device actions may include mimicking at least one of a keyboard entry and a mouse click.

A method for transferring a structured document between a software package and a server, in accordance with the present invention, includes providing a transaction from a software package, extracting the transaction represented in the software package by translating the transaction into a structured document using a program for directly extracting information from the software package without human intervention, and integrating the structured document onto a server. The only functionality included in the software package for extracting the information from the software package is a manual interface requiring a plurality of human interface device inputs. The program may include operating system commands for automating the plurality of human interface device inputs to extract the information from the software package.

In other methods, the step of extracting may include the step of moving the transaction from the software package by employing a programming interface provided by the software package. The step of extracting may include the step of moving the transaction from the software package by creating a computer file in a format that can be exported from the software package. The structured document may include a business document, and the software package may include business software. The structured document may include one of an invoice and a purchase order and the software package may include accounting software. The structured document may include an extensible markup language (XML) document, and the step of integrating may include the step of providing the XML document from another format using an extensible stylesheet language (XSL) document and an XSL processor. The step of extracting may include the steps of converting the transaction to an intermediate format, and converting the intermediate format to the structured document for use by the server. The step of extracting may include the step of invoking input and output adapters associated with the transaction for, respectively, parsing and creating an output format for the transaction. The methods and method steps may be implemented by employing a program storage device readable by machine, tangibly embodying a program of instructions executable by the machine to perform the method steps. The plurality of human interface device inputs may include a plurality of keyboard entries and mouse clicks. The software package may include an accounting software package.

A method for transferring a transaction between a server and a software package includes the steps of providing an initial structured document including entered information from a server, translating the initial structured document into a format understandable to a commercial software package, preserving additional information needed for a return document, integrating the translated structured document into the commercial software package by employing a program independent of the commercial software package for directly entering and extracting information to and from the software package without human intervention and creating the return document by merging the extracted information and the additional information. The step of entering and extracting the information using only the commercial software package requires using a user interface in the commercial software package. The user interface is accessible using only a series of human interface actions. The program may include operating system commands for mimicking the series of human interface actions for automatically interfacing with the user interface.

In other methods, the step of integrating may include the step of moving a transaction represented by the structured document into the software package by employing a programming interface provided by the software package. The step of integrating may include the step of moving a transaction represented by the structured document into the software package by creating a computer file in a format that can be imported into the software package. The structured document may include a business document, and the software package may include business software. The structured document may include one of an invoice and a purchase order, and the software package may include accounting software. The structured document may include an extensible markup language (XML) document, and the step of translating may include the step of converting the XML document to another format using an extensible stylesheet language (XSL) document and an XSL processor. The step of translating may include the step of converting the structured document to and from an intermediate format. The step of preserving additional information needed for a return document may include the step of preserving the additional fields in the intermediate format until the additional fields are merged into the return document. The step of preserving additional information needed for a return document may include the step of storing the additional fields until the additional fields are merged into the return document. The step of translating may include the step of invoking input and output adapters associated with the structured document for, respectively, parsing and creating an output format for the structured document. The methods and method steps may be implemented by employing a program storage device readable by machine, tangibly embodying a program of instructions executable by the machine to perform the method steps. The accounting software package may be one of PEACHTREE™ and QUICKBOOKS™. The accounting software package may be one of PEACHTREE™ 5.0 and QUICKBOOKS™ 5.0.

These and other objects, features and advantages of the present invention will become apparent from the following detailed description of illustrative embodiments thereof, which is to be read in connection with the accompanying drawings.

### BRIEF DESCRIPTION OF DRAWINGS

The invention will be described in detail in the following description of preferred embodiments with reference to the following figures wherein:

FIG. 1 is a block/flow diagram showing a system/method for transferring a structured document to and from a software application in accordance with the present invention;

FIG. 2A is a schematic diagram showing an e-commerce server and an accounting package interoperating with format translation executed at the server and accounting package integration executed at the client in accordance with the present invention;

FIG. 2B is a schematic diagram showing an e-commerce server and an accounting package interoperating with both format translation and accounting package integration executed at the client in accordance with the present invention;

FIG. 3 is a flow diagram showing an XML document translated to another format in accordance with the invention;

FIG. 4 is a schematic diagram showing format translation performed using an intermediate representation of a business document in accordance with the present invention;

FIG. 5 is a schematic diagram showing the use of in and out adapters for translation from EDI formats in accordance with the invention;

FIG. 6 is a schematic diagram showing the use of in and out adapters for translation from XML formats in accordance with the invention;

FIG. 7A is a schematic diagram showing business documents transferred between a client into an accounting package in accordance with the present invention;

FIG. 7B is a schematic showing business documents transferred into the client from the accounting package in accordance with the present invention;

FIG. 8 is a block/flow diagram showing an illustrative translation flow in accordance with the present invention;

FIG. 9 is a block/flow diagram showing an illustrative in adapter flow in accordance with the present invention;

FIG. 10 is a block/flow diagram showing an illustrative out adapter flow in accordance with the present invention;

FIG. 11 is a block/flow diagram showing an illustrative integration flow of a document into a software package in accordance with the present invention;

FIG. 12 is a block/flow diagram showing an illustrative flow of a document from a software package in accordance with the present invention;

FIG. 13 is a schematic diagram showing an illustrative flow for handling additional fields in an initial document by re-accessing the initial document in accordance with the present invention; and

FIG. 14 is a schematic diagram showing an illustrative flow for handling additional fields in an initial document by storing the additional fields of the initial document in accordance with the present invention.

### DETAILED DESCRIPTION OF PREFERRED EMBODIMENTS

The present invention is related to e-commerce and automated document exchanges between a server and a client with access to an accounting software program. The present invention provides for the integration of business documents and application software. In a particularly useful embodiment of the present invention, the integration (i.e., entry) of business documents between a browser and a PC accounting package is automated with an applet running in the browser. The server, which is responsible for the format of the data being served to and collected from clients, is preferably the provider of this applet.

Some advantages of automated integration over human entry include speed, ease, and accuracy. Integration may be almost instantaneous, and include only a couple of mouse clicks instead of retyping an entire business document. In addition, human-created errors can be minimized since it is no longer necessary to retype the data in the documents. One other advantage of automating the entry and extraction of transactions at the client is users will not need to use functions of application software which they are typically unaccustomed to using, such as “import” and “export.” While a browser in today's environment may include a Web browser, the present invention applies to other clients as well.

The present invention can automate integration between the company's e-commerce server and its trading partners' PC accounting packages or other software packages. The present invention provides format translation and accounting or application package integration. Format translation takes the document from the e-commerce server in the server's given format and converts the document to the format needed for PC accounting package integration. Similarly, the reverse is performed for reply documents. Application package integration includes interfacing to the PC accounting or application package including the use of operating system events to mimic human interactions such as keyboard entry and/or mouse movements and clicks. For simplicity, the present invention will now be described in terms of an accounting package for Internet based e-commerce. However, the present invention is much broader and is applicable to any application software for Internet or other network interactions.

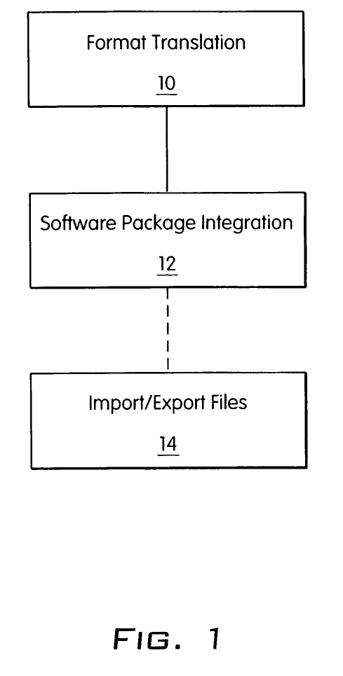

It should be understood that the elements shown in the FIGS. may be implemented in various forms of hardware, software or combinations thereof. Preferably, these elements are implemented in software on one or more appropriately programmed general purpose digital computers having a processor and memory and input/output interfaces. Referring now to the drawings in which like numerals represent the same or similar elements and initially to FIG. 1, a system/method for server to accounting package interoperability is shown in accordance with the present invention.

Integration between large backend systems such as, for example, Enterprise Resource Planning (ERP) packages with front-end systems such as, on-line stores and EDI systems is desirable. This integration is done with large, robust middleware. To integrate business documents into accounting packages, there is a need to interface business objects (such as invoices) from a document in the browser directly with the accounting system running on the PC.

Instead of a specific solution that handles the conversion between two specific business systems, the present invention includes the development of a more generic solution that will permit quick and easy development of integration with many systems.

Yoda (Your Data Anywhere) is a Research prototype of the present invention, developed by the inventors, which aims to solve the problem, with an applet or program that can run in a Web browser.

FIG. 1 depicts a block diagram showing main steps of the present invention. Step 10 includes format translation, and step 12 includes application package integration. In step 10, Yoda format translation is performed. The step of integration, in block 10, translates an incoming document into a format that Yoda can understand, that is, one of the formats supported by the Yoda accounting package integration (see step 12, below). Yoda has been extended with, for example, an XML (extensible Markup Language) translator, a tool that translates an XML document in one format to an XML document of another format using a simple map. Other formats are also contemplated, such as SGML or HTML, for example. The tool also supports translation of EDI documents into XML. Instead of having a Yoda in adapter for each XML document type, only one such adapter is needed with maps from different XML document types.

By using XSL (extensible Stylesheet Language), format translation can be avoided. Instead, a comma-delimited import file, for example, is created directly from an XML document.

When the e-commerce server uses an XML format to store the business documents, XSL may be used to do the format translation to create the document in the format needed for accounting packages. Another method of format translation used by Yoda uses an intermediate representation of business objects. To move an object from a source business system to a target system, an in adapter and an out adapter may be employed. The in adapter creates an intermediate object by accessing the source system. The out adapter passes this object as input and creates the object in the target system. The server keeps a library of these adapters accessible by object type, system type, and adapter type (either in or out).

In step 12, a Yoda accounting package integration includes, for example, a Java applet which runs in a browser. It has an intermediate representation of business objects. To move an object from a source business format to the target accounting package, an in adapter and an out adapter are employed. The in adapter creates an intermediate object by accessing the source system. The out adapter passes the object as input and creates the object in the target system. Yoda keeps a library of these adapters accessible by object type, system type, and adapter type (either in or out). The adapters can access an existing system through known application program interfaces (APIs), through standard access methods such as JDBC (Java Database Connectivity), RMIs or through standard exchange formats such as EDI (electronic data interchange) and comma-delimited files.

For accounting package integration, an applet or program running in the client (a browser) may be employed. For accounting packages that do not have direct interfaces, such as, for example, PEACHTREE 5.0 (commercially available from Peachtree, Inc.) and/or QUICKBOOKS 5.0 (commercially available from Intuit, Inc.), a signed applet is used to write import files to and read export files from the trading partner's PC. The import files can be used to import the business documents from inside the accounting package; the export files are created by exporting the business documents from inside the accounting package. Next, the applet mimics the actions (that is, keyboard entries and/or mouse movements and clicks) that a user would take to import the business document into or export the business document out of the accounting package. The applet mimics these actions by executing a program that contains the creation of operating system events that correspond to these keyboard entries and mouse movements and clicks. With the applet performing these actions, no user intervention is required—a major advantage as typical users are unfamiliar with importing and exporting documents from within the accounting packages.

With some operating systems it is possible to replace having the applet execute the mimicking of human actions with a program assigned in the operating system to the file type of the import file created by the applet. This assignment can be done as a separate installation. The assigned program would then execute the mimicking of the human actions. The operating program will automatically execute the assigned program whenever the created file is opened. Within browsers, a default can be set to always open a file of a particular type when it is downloaded. In HTML, file types can be specified with a meta tag.

Newer versions of the PC accounting packages such as PEACHTREE for Office allow external programs to perform accounting actions such as order creation via published programming interfaces. These interfaces allow for an applet to have seamless integration without resorting to the use of import and export files. Again, this is a major advantage as the typical user is unfamiliar and uncomfortable with using importing and exporting from within the accounting packages.

The present invention includes at least the following advantages:
1) An applet or program running in the browser can directly enter data in to the PC accounting package with or without human intervention even when the PC accounting package only supports business document creation via human interfaces; and
2) An applet or program running in the browser can extract data from the PC accounting package with or without human intervention even when the PC accounting package only supports business document extraction via human interfaces.

For older accounting packages that do not support open programming interfaces, such as PEACHTREE release 5.0 and QUICKBOOKS version 5.0, the way for Yoda to integrate is via import and export files in step 14. Yoda creates the format these packages need to import sales orders, for example. Similarly, Yoda parses the formats in which these packages export invoices, for example.

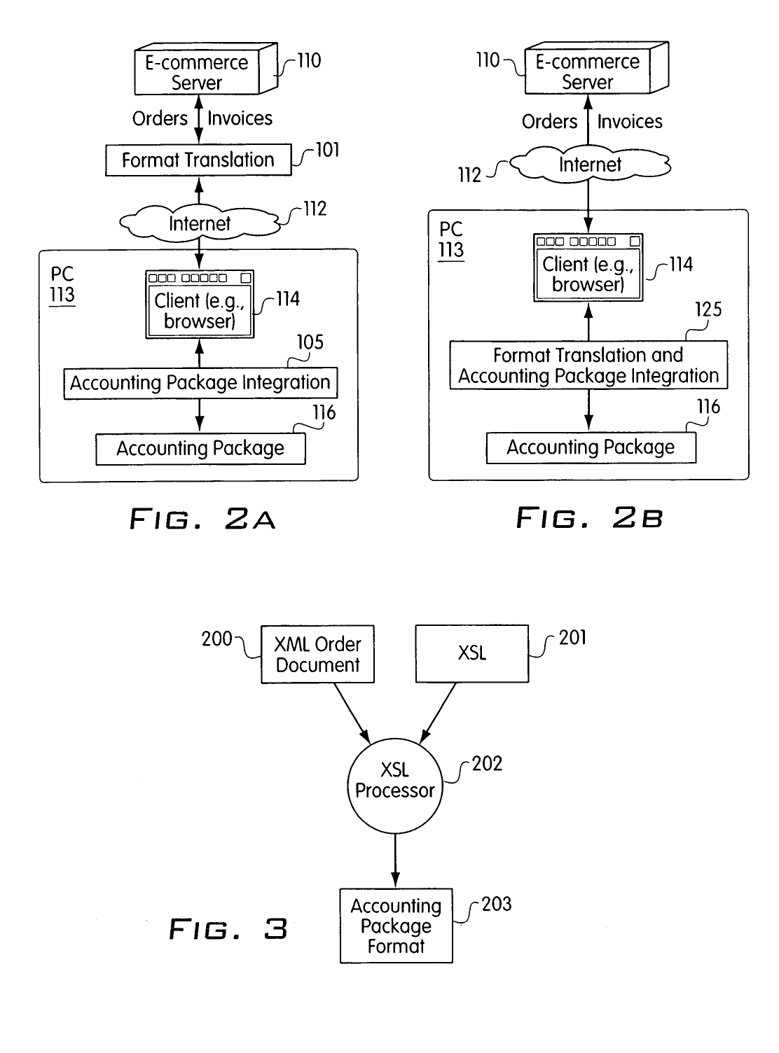

Referring to FIGS. 2A and 2B, two potential flows of business documents between an e-commerce server 110, and a client 114 running on a same PC 113 as an accounting package 116 are shown. The e-commerce server 110 is responsible for serving out and accepting in business documents such as, for example, orders and invoices, over the Internet 112 to and from clients 114 run by trading partners, for example. A common client in today's environment may include a Web Browser.

In FIG. 2A, format translation 101, which includes converting a business document from one format to another, is performed at server side (FIG. 2A). That is, for a business document being served out by the server, the translation of the document to a format that the accounting package 116 at the client (FIG. 2B) can understand is done at the server before being passed to the client 114 over the Internet 112. Similarly, for documents being sent into the server 110 from the client 114 over the Internet 112, translation from the client-provided format to the server-expected format is done at the server 110.

Accounting package integration 105 is performed at the PC 113 where the accounting package 116 resides. Today's commonly used PC accounting packages only permit transactions such as orders and invoices to be entered and accessed at the PC 116. Accounting package integration, 105 is used to take the business document received by the client 114 and integrate that document into the accounting package 116. Similarly, business documents in the accounting package 116 are extracted via accounting package integration 105 to enable the business document to be sent over the Internet 112 to the e-commerce server 110.

FIG. 2B shows how the documents can be exchanged with both the format translation and the accounting package integration 125 taking place at the client 114. This differs from FIG. 2A where format translation is done at the server 110. In FIG. 2B, the client 114 receives documents from the server 110 and sends documents to the server 110 in the server's format as opposed to the accounting package format as in FIG. 2A.

Different mechanisms may be employed for the implementation of format translation. For example, when converting an XML (Extensible Markup Language) document as the source, XSL (Extensible Stylesheet Language) and an XSL processor can be used. Alternatively, intermediate business objects can be used with translation occurring to and from these objects.

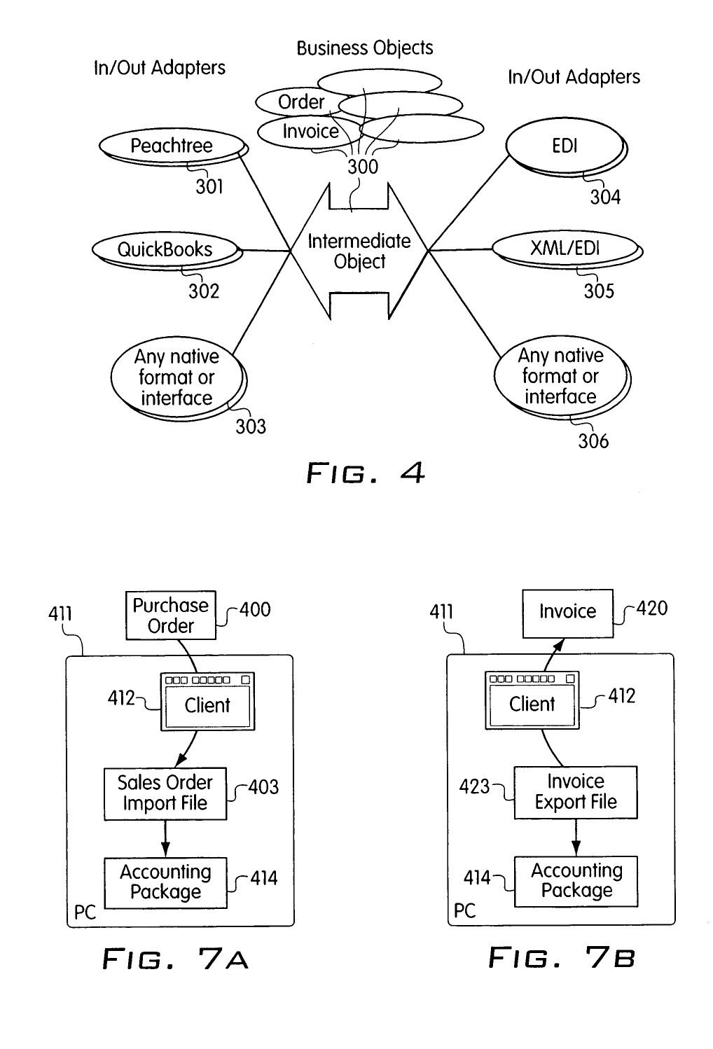

Referring to FIG. 3, a example flow of format translation using XSL is shown. An order document in XML format 200 as well as an XML document, 201 including code, which may be written in JavaScript, are fed into an XSL processor 202 such as the LOTUSXSL processor, for example. The XSL processor 202 outputs the accounting package format 203. This type of conversion will work for any XML document for which an XSL has been written for that class of XML formatted documents.

Referring to FIG. 4, another method for format translation is shown in accordance with the present invention. Intermediate business object formats 300 are defined. For each particular input and output format there is an adapter (301 through 306). An input adapter parses the input format and creates the appropriate business object, for example, a JAVA object. An output adapter creates the output format from the corresponding business object. Performing a translation includes invoking a proper input and output adapter(s) with the input document. When this technique for format translation is performed at the client, the adapters can access an existing system through known APIs (Application Programming Interfaces), such as PEACHTREE for Office's OLE (Microsoft's Object Linking and Embedding) interface, or through standard access methods such as JDBC (Java Database Connectivity).

By using input and output adapters to and from an intermediate format instead of direct translations, for n different input formats and m different output formats, only n+m adapters are needed to be written as opposed to n*m translations. For large numbers of input and output formats, the savings from this use of an intermediate format is substantial. Also, when integrating a new system or format at one end, only 1 new adapter needs to be created, as opposed to creating n or m translations.

Many PC accounting packages available today still do not support automated insertion and extraction of business transactions such as orders and invoices to and from external sources.

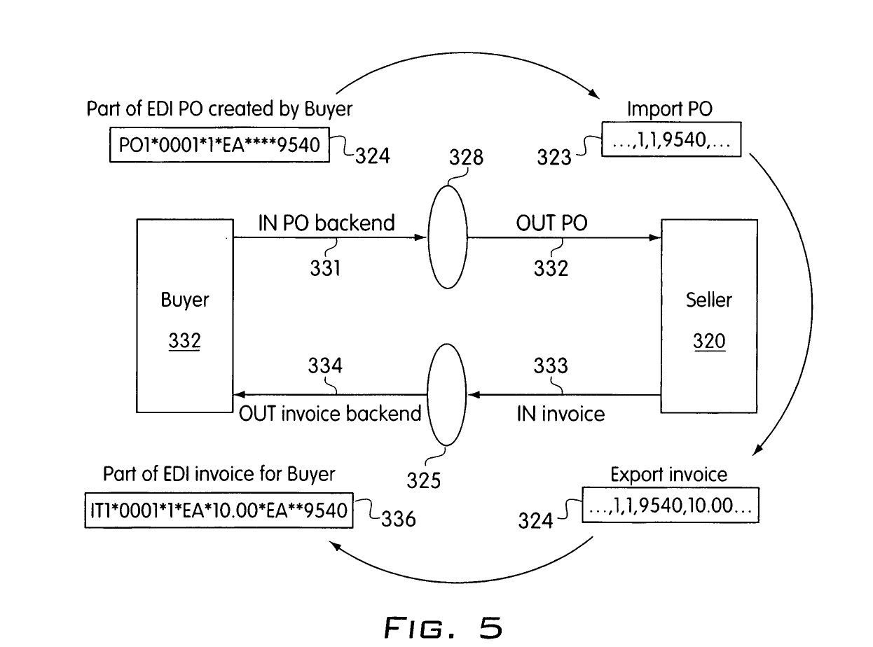

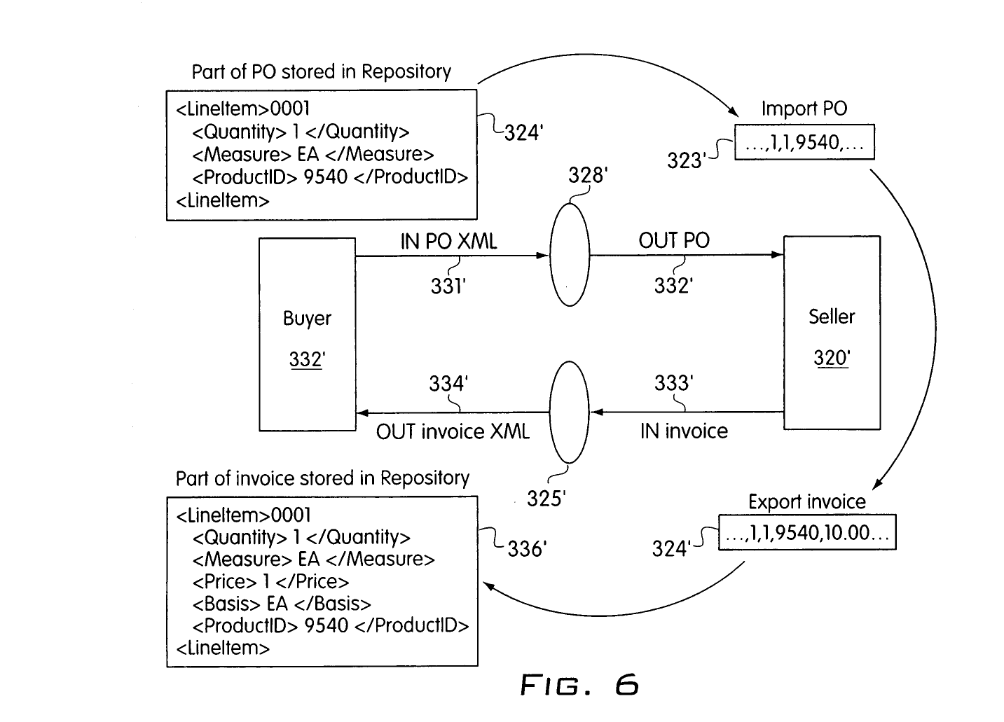

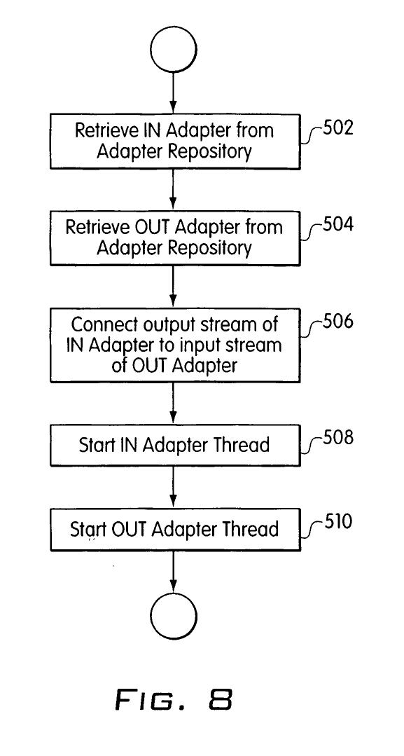

Referring to FIGS. 5 and 6, illustrative examples of using input and output adapters to and from an intermediate format instead of using direct translations are shown. FIG. 5 shows transactions from EDI format; while FIG. 6 shows transactions from XML using in and out adapters. In FIG. 5, a buyer 322 sends a purchase order (PO) 324 to a seller 320 in EDI format. An in adapter 331 converts the PO to an intermediate format object 328. The intermediate object 328 is converted to an application formatted import file 323, for example, a Peachtree import file by an out adapter 332 which can be employed by seller 320. An invoice (export file) 324 is appropriately generated using an in adapter 333 which converts the export file to an intermediate object 325. The intermediate object 325 is then converted to an EDI invoice 336 by an out adapter 334. To be employed by buyer 322.

FIG. 6 shows the same example employing an XML format from buyer 332′. In FIG. 6, a buyer 322′ sends a purchase order (PO) 324′ to a seller 320′ in XML format. An in adapter 331′ converts the PO to an intermediate format object 328′. The intermediate object 328′ is converted to an application formatted import file 323′, for example, a Peachtree import file by an out adapter 332′ which can be employed by seller 320′. An invoice (export file) 324′ is appropriately generated using an in adapter 333′ which converts the export file to an intermediate object 325′. The intermediate object 325′ is then converted to an XML invoice 336′ by an out adapter 334′ to be employed by buyer 322′.

The intermediate objects described above may be created by mapping objects in other formats or applications with a set of intermediate objects. Table 1 shows some illustrative examples of intermediate objects employed for purchase order fields. Other intermediate objects and applications are also contemplated.

TABLE 1
Illustrative Intermediate Objects

| Order Field for | | |
|---|---|---|
| Intermediate Object | PEACHTREE | QUICKBOOKS |
| BuyerId | CustomerId | Name ( ) |
| ShiptoName | Ship to Name | SADDR1 (AR) |
| Terms | Displayed Terms | TERMS (AR) |
| LineItemQuantity [i] | Quantity | QNTY (LI) |

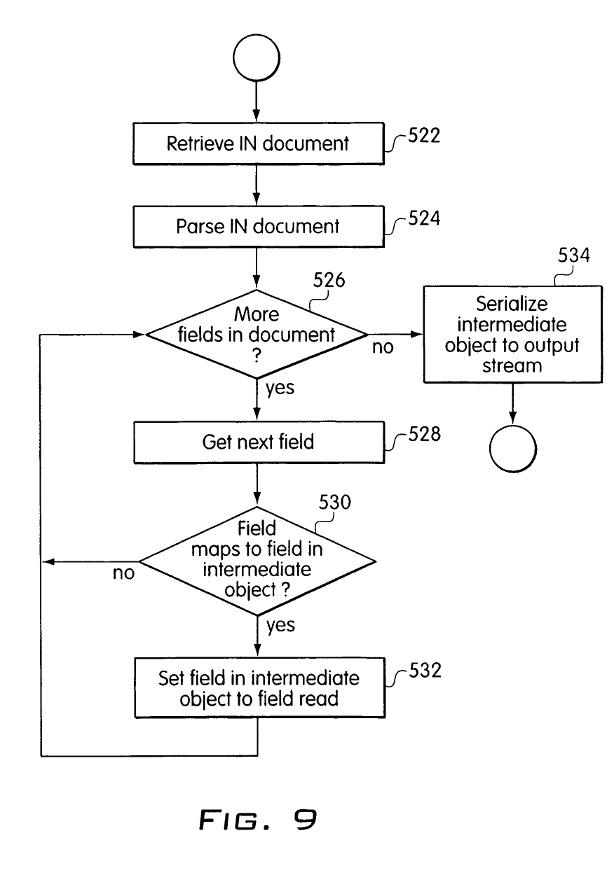

Referring to FIGS. 7A and 7B, two illustrative ways in which integration with accounting packages via import and export files is shown. These types of integration are needed when the accounting packages do not have any other interface, such as, APIs.

In FIG. 7A, a purchase order 400 is passed from a client 412, such as a browser, to an accounting package 414, via an import file 403. The import file 403 is created by the browser and stored on a PC 411 on which both the browser 412 and the accounting package 414 are located. User actions initiate the import of the import file from within the accounting package. By executing a program that issues operating system commands, these user actions can be mimicked in an automated fashion.

Once the order is shipped and an invoice 420 needs to be created, the invoice 420 is sent back to the business server from the browser 412. The creation of this invoice 420 is shown in FIG. 7B. From within the accounting package 414, user actions initiate an export of an invoice file 423, which is stored on the PC 411. By executing a program that issues operating system commands, these user actions can be mimicked in an automated fashion. Then, from the client 412, the invoice file 420 can be read from a hard drive or other memory storage device on PC 114 and sent to a business server.

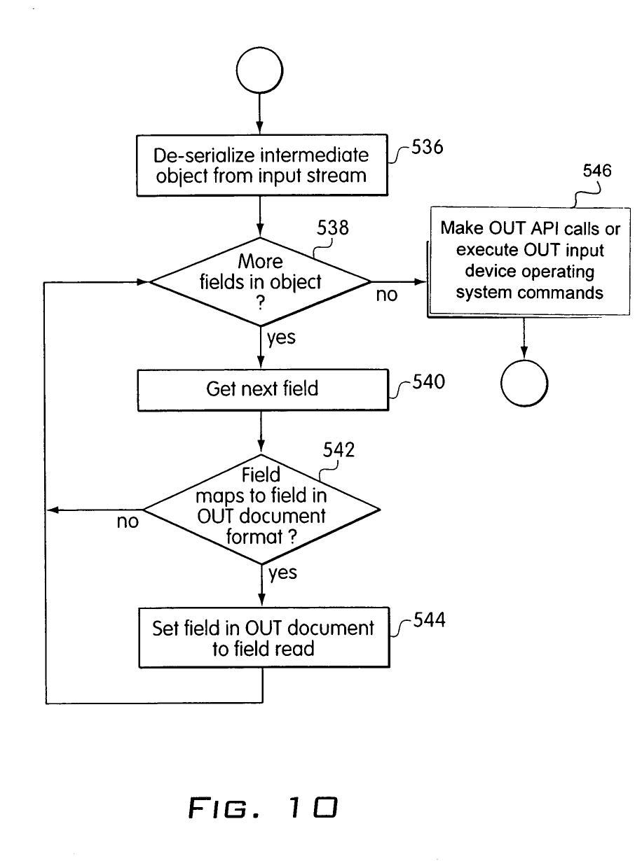

Referring to FIG. 8, an illustrative applet or program is shown for integrating, for example, a business document and accounting software in accordance with the present invention. Format translation flow in accordance with the present invention includes retrieving an in adapter, in block 502. The in adapter is selected for a repository of adapters in accordance with the format of the information input thereto and the format needed by the output of the in adapter. In block 504, an out adapter is also selected from the repository based on the format requirements input to and output from the out adapter. In block 506, the output stream of the in adapter is connected to the input stream of the out adapters. In blocks 508 and 510, the thread to be translated is started through the adapters.

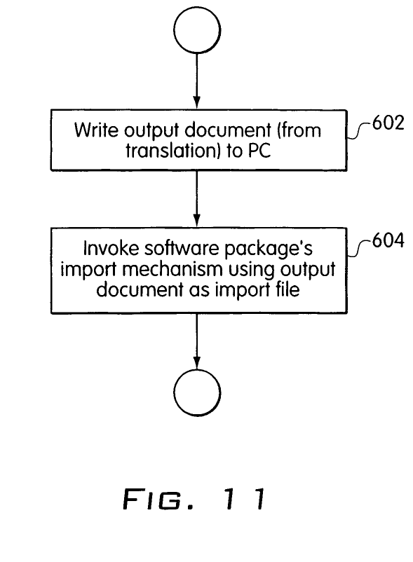

Referring to FIG. 9, an in adapter flow is shown in accordance with the invention. In block 522, an IN document is retrieved for translation. The IN document is parsed in block 524. In block 526, it is determined if there are more fields in the IN document remaining to be translated. If more fields are present, the next field is retrieved in block 528. In block 530, it is determined whether the field can be mapped to an intermediate object. If the field can be mapped to an intermediate object, the field is set to field read to read the field into the intermediate object in block 532. This is performed until all fields have been processed. Then, block 534, serializes intermediate objects to an output stream (see FIG. 10).

Referring to FIG. 10, process flow for an out adapter is illustratively shown in accordance with the invention. In block 536, an input stream (for example, the output stream from in adapter flow of FIG. 9) is received and de-serialized to retrieve intermediate objects. In block 538, it is determined if there are more fields in the intermediate document remaining to be translated. If more fields are present, the next field is retrieved in block 540. In block 542, it is determined whether the field can be mapped from the intermediate object in an OUT document format. If the field can be mapped to the OUT document format, the field is set to field read to read the field into the OUT document format in block 544. This is performed until all fields have been processed. Then, block 546, enters the business document into the target system by either: calling an appropriate API or, if no such API exists, executing a program to mimic the human input needed to bring in a business document. This program comprises operating system commands that mimic keyboard entry, mouse movements and clicks, or some other human-computer interface.

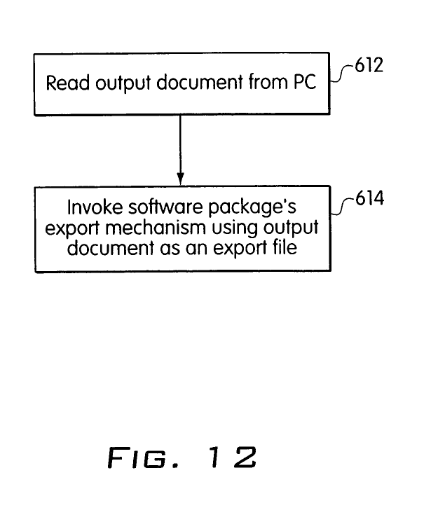

Referring to FIG. 11, process flow for integrating an import file into an application, such as an accounting package, is illustratively shown. An import file may be needed if the application does not include an API compatible with format translation, as described above. In block 602, an output or OUT document (from translation) is written to a PC. The accounting or application package has its appropriate import mechanism invoked using the OUT document as an import file, in block 604. This invocation comprises executing a program that has a series of operating system commands. These commands mimic the computer interface steps (typically keyboard entry and/or mouse movement or clicks) that a human would take when invoking the PC accounting package import function. The translated information is now seamlessly available for a user of the software application.

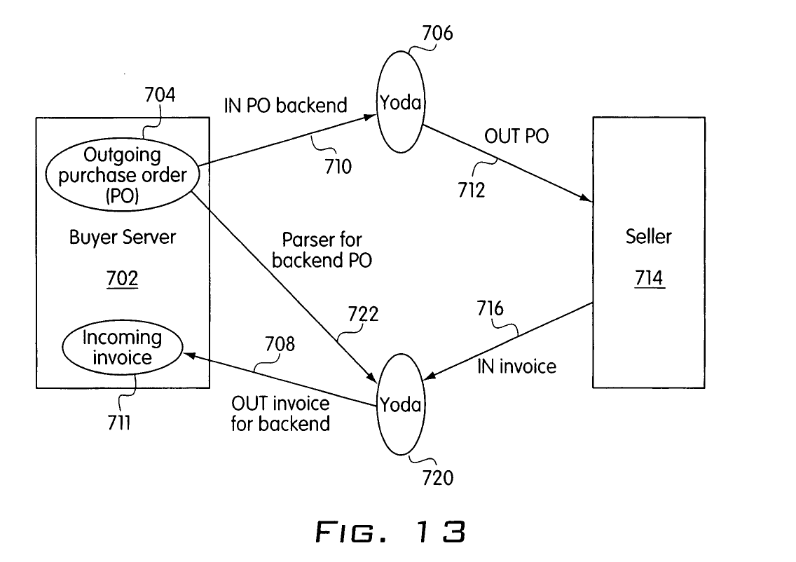

Referring to FIG. 12, process flow for integrating an export file into a server is illustratively shown. In block 612, an output document (from application) is read to a server. The accounting or application package has its appropriate export mechanism invoked using the output document as an export file, in block 614. This invocation comprises executing a program that has a series of operating system commands. These commands mimic the computer interface steps (typically keyboard entry and/or mouse movement or clicks) that a human would take when invoking the PC accounting package export function. The information of the output document is translated for seamless processing at the server.

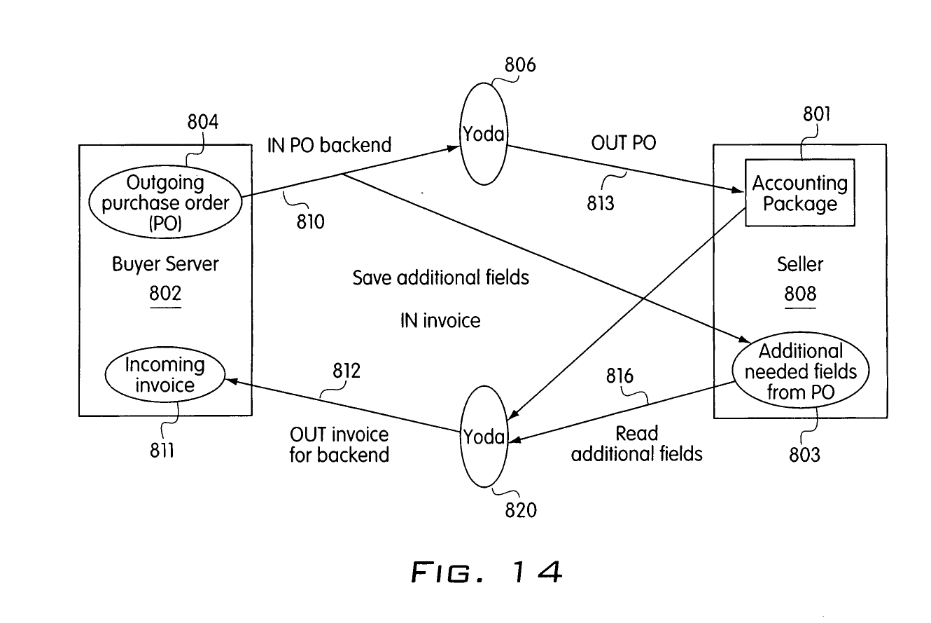

Referring to FIGS. 13 and 14, in some situations input documents for translation may include additional information or fields which may not have corresponding intermediate object fields. FIGS. 13 and 14 illustratively address how to handle the use of “rich” document formats on a server. For example, when a buy's server is using EDI for its outgoing purchase orders and incoming invoices, during the import of the order into an accounting package, the client or buyer would lose this additional information which may be needed during invoice creation. Sales orders within the PC accounting packages only support a subset of the fields used in EDI. In other words, for the creation of a rich format invoice, there is a need to include data from the original purchase order which is not included in the accounting package.

As illustratively shown in FIG. 13, a buyer server 702 includes an outgoing document, purchase order (PO) 704, having some fields corresponding to available intermediate objects 706 and additional information needed for a return document or invoice creation but not needed for purchase order processing. The purchase order data will be processed to an intermediate object 706 by an in adapter 710 and retrieved and parsed by from server 702 within an invoice out adapter 708. PO data will be translated as described above employing in adapter 710 and out adapter 712 using intermediate object 706. A seller 714 receives the PO in an application, such as, an accounting application, and manipulates the PO data as needed. An invoice is generated using the PO data transferred from the application of seller 714 by in adapter 716. Out adapter 708 will create the output invoice document in the buyer's server format by merging the fields from an intermediate object 720 created by the application's in adapter 716 with the additional fields of the parsed purchase order 722.

As shown in FIG. 14, a buyer server 802 includes an outgoing purchase order (PO) 804 having some fields corresponding to available intermediate objects 806 and additional information 803 needed for invoice or return document creation but not needed for purchase order or initial document processing. The purchase order data will be processed to an intermediate object 806 by an in adapter 810. The additional fields or data are stored on the client or seller's system 808. A software package, such as an accounting package 801 seamlessly receives the translated PO from an out adapter 813 and manipulates the data as needed. Later, when the invoice 811 or return document needs to be generated with the additional information, the additional information 803 is accessed by an out adapter 812 which merges the additional fields with an intermediate object 820 created by the application's in adapter 816.

Having described preferred embodiments for interoperability of accounting packages and commerce servers (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A method for transferring a transaction between a server and a software package comprising the steps of:
providing a structured document including entered information from a server;
translating the structured document into a format understandable to a software package resident on a personal computer, wherein said software package supports entering and extracting required information using only a user interface in the software package; and
integrating the translated structured document into the software package by employing a program for automatically entering and extracting information to and from the software package without human intervention;
wherein the program comprises operating system commands for mimicking input device actions for automatically interfacing with the user interface.

2. The method as recited in claim 1, wherein the step of integrating includes the step of moving a transaction represented by the structured document into the software package by employing a programming interface provided by the software package.

3. The method as recited in claim 1, wherein the step of integrating includes the step of moving a transaction represented by the structured document into the software package by creating a computer file in a format that can be imported into the software package.

4. The method as recited in claim 1, wherein the structured document includes a business document and the software package includes business software.

5. The method as recited in claim 1, wherein the structured document includes one of an invoice and a purchase order and the software package includes accounting software.

6. The method as recited in claim 1, wherein the structured document includes an extensible markup language (XML) document and the step of translating includes the step of converting the XML document to another format using an extensible stylesheet language (XSL) document and an XSL processor.

7. The method as recited in claim 1, wherein the step of translating includes the steps of:
converting the structured document to an intermediate format; and
converting the structured document from the intermediate format to the format understandable to the software package.

8. The method as recited in claim 1, wherein the step of translating includes the step of invoking input and output adapters associated with the structured document for, respectively, parsing and creating an output format for the structured document.

9. A program storage device readable by machine, tangibly embodying a program of instructions executable by the machine to perform method steps as recited in claim 1.

10. A method for transferring a structured document between a software package and a server comprising the steps of:
providing a transaction from a software package;
extracting the transaction represented in the software package by translating the transaction into a structured document using a program for directly extracting information from the software package without human intervention; and
integrating the structured document onto a server;
wherein the only functionality included in the software package for extracting the information from the software package is a manual interface requiring a plurality of human interface device inputs; and
wherein the program comprises operating system commands for automating the plurality of human interface device inputs to extract the information from the software package.

11. The method as recited in claim 10, wherein the step of extracting includes the step of moving the transaction from the software package by employing a programming interface provided by the software package.

12. The method as recited in claim 10, wherein the step of extracting includes the step of moving the transaction from the software package by creating a computer file in a format that can be exported from the software package.

13. The method as recited in claim 10, wherein the structured document includes a business document and the software package includes business software.

14. The method as recited in claim 10, wherein the structured document includes one of an invoice and a purchase order and the software package includes accounting software.

15. The method as recited in claim 10, wherein the structured document includes an extensible markup language (XML) document and the step of integrating includes the step of providing the XML document from another format using an extensible stylesheet language (XSL) document and an XSL processor.

16. The method as recited in claim 10, wherein the step of extracting includes the steps of:
converting the transaction to an intermediate format; and
converting the intermediate format to the structured document for use by the server.

17. The method as recited in claim 10, wherein the step of extracting includes the step of invoking input and output adapters associated with the transaction for, respectively, parsing and creating an output format for the transaction.

18. A program storage device readable by machine, tangibly embodying a program of instructions executable by the machine to perform method steps as recited in claim 10.

19. A method for transferring a transaction between a server and a commercial software package comprising the steps of:
providing an initial structured document including entered information from a server;
translating the initial structured document into a format understandable to a commercial software package;
preserving additional information needed for a return document;
integrating the translated structured document into the commercial software package by employing a program independent of the commercial software package for directly entering and extracting information to and from the commercial software package without human intervention; and
creating the return document by merging the extracted information and the additional information;
wherein entering and extracting the information using only the commercial software package requires using a user interface in the commercial software package, said user interface accessible using only a series of human interface actions; and
wherein the program comprises operating system commands for mimicking the series of human interface actions for automatically interfacing with the user interface.

20. The method as recited in claim 19, wherein the step of integrating includes the step of moving a transaction represented by the structured document into the software package by employing a programming interface provided by the software package.

21. The method as recited in claim 19, wherein the step of integrating includes the step of moving a transaction represented by the structured document into the software package by creating a computer file in a format that can be imported into the software package.

22. The method as recited in claim 19, wherein the structured document includes a business document and the software package includes business software.

23. The method as recited in claim 19, wherein the structured document includes one of an invoice and a purchase order and the software package includes accounting software.

24. The method as recited in claim 19, wherein the structured document includes an extensible markup language (XML) document and the step of translating includes the step of converting the XML document to another format using an extensible stylesheet language (XSL) document and an XSL processor.

25. The method as recited in claim 19, wherein the step of translating includes the step of converting the structured document to and from an intermediate format.

26. The method as recited in claim 25, wherein the step of preserving additional information needed for a return document includes the step of preserving the additional fields in the intermediate format until the additional fields are merged into the return document.

27. The method as recited in claim 25, wherein the step of preserving additional information needed for a return document includes the step of storing the additional fields until the additional fields are merged into the return document.

28. The method as recited in claim 19, wherein the step of translating includes the step of invoking input and output adapters associated with the structured document for, respectively, parsing and creating an output format for the structured document.

29. A program storage device readable by machine, tangibly embodying a program of instructions executable by the machine to perform method steps as recited in claim 19.

30. The method of claim 1, wherein mimicking input device actions comprises mimicking at least one of a keyboard entry and a mouse click.

31. The method of claim 10, wherein the plurality of human interface device inputs comprises a plurality of keyboard entries and mouse clicks.

32. The method of claim 10, wherein the software package comprises an accounting software package.

33. The method of claim 32, wherein the accounting software package comprises one of PEACHTREE™ and QUICKBOOKS™.

34. The method of claim 32, wherein the accounting software package comprises one of PEACHTREE™ 5.0 and QUICKBOOKS™ 5.0.
